(19) United States
(12) Patent Application Publication
(10) Pub. No.: US 2022/0252549 A1
(43) Pub. Date: Aug. 11, 2022

(54) SYSTEM AND METHOD FOR MORE EFFICIENT ULTRASONIC INSPECTION OF JET-ENGINE DISKS

(71) Applicant: SCANMASTER SYSTEMS (IRT) LTD., Kfar Saba (IL)

(72) Inventors: Michael BRON, Petach Tikva (IL); David GAL, Neve Monoson (IL); Silviu RABINOVIC, Maccabim (IL)

(73) Assignee: SCANMASTER SYSTEMS (IRT) LTD., Kfar Saba (IL)

(21) Appl. No.: 17/429,776

(22) PCT Filed: Feb. 10, 2021
(86) PCT No.: PCT/IL2019/050161

§ 371 Date: Aug. 10, 2021

(51) Int. Cl. G01N 29/22; G01B 17/00; G01M 15/14; G01N 29/26; G01N 29/265

(52) U.S. Cl. CPC G01N 29/225; G01B 17/00; G01N 2291/2693; G01N 29/262; G01N 29/265; G01M 15/14

(57) ABSTRACT

An inspection system comprising a first and second computer controlled robotic arm that each have five degrees of freedom (x, y, z, α, β) and respectively control position and tilt of first and second probes for inspection of a workpiece, wherein the computer control ensures that the two robotic arms simultaneously scan the probes over the workpiece, without interfering with each other.

### BACKGROUND

Turbine blades, rotors and particularly jet engine bladed disks, are designed to operate at very high temperatures and may undergo thermal cycling. Sand and debris ingested into and passing through the jet engines may create wear and impact damage to the bladed disks. Additional, internal flaws from the manufacturing process may propagate to critical size and cause catastrophic failure.

Bladed disk manufacture and subsequent maintenance inspection require extensive non-destructive testing NDT. NDT enables flaws to be identified, characterized and mapped, and subsequently monitored for flaw growth, preventing dangerously flawed components from entering or remaining in service

Phased array inspection reduces the time of NDT since different depths and/or different angles are scanned at the same time. However, due to poor near surface resolution and other limitations, use of phased array inspection techniques alone does not render traditional single probe inspection obsolete.

In the past, Scanmaster™ has introduced systems that use an immersion tank with a turntable mounted chuck for holding a bladed disk, and a single probe holder having five degrees of freedom (x, y, z, α, β) where x, y and z, are mutually orthogonal Cartesian axes, and a and are tilt and yaw, to enable scanning bladed disks and other workpieces, whilst ensuring that the probe is properly positioned with respect to the surface of the workpiece being scanned.

Due to the need for the probe to be properly oriented to the surface being scanned, it is not possible to mount both phased array and traditional probes side by side or one over the other on the same holder so that they are moved in unison. By providing a quick switching holder, a standard inspection probe may be interchanged with a phased array inspection probe, and thus the same equipment set may be used to conduct both types of scans for the same chuck mounted workpiece, with the only loss of time being that for switching from one probe to another.

The combination of phased array and conventional ultrasonic hardware in one system allowed for multizone and multi-angle inspection. However it presented technological challenges as it required a single operator to be familiar with different hardware and user interfaces Scanmaster™ solved this problem by integrating phased array hardware into the immersion system, paying special attention to positional synchronization and data transfer interfaces. They developed a probe holder having fast exchange capabilities and high placement accuracies that could accept conventional, annular and linear array probes, and software for easy maintenance of ultrasonic testing UT setups and for analysis of the inspection results from different inspection zones.

Each workpiece has to be separately positioned on the turntable within the ultrasonic bath, and scanned twice. However, this is much faster than only using one type of probe or separate systems with separate mountings. A quick exchange chuck introduced by Scanmaster™ reduced the probe exchange time by a further 20 minutes.

By interchanging the probes and scanning the workpiece twice, multi-zone inspection scanning of a typical 527 mm outer diameter disk with 10 faces was reduced from 346 minutes (seven hours) to 258 minutes (88 minutes less), taking about 25% less time, providing a saving of 88 minutes, and a multiple angle inspection of the disk took 266 minutes instead of 336 minutes, representing a 21% time saving.

To increase the production and reengineering rate of key jet engine components such as bladed disks to meet increased demand, it is necessary to make the NDT inspection ever more efficient. The present invention addresses this need.

### SUMMARY OF THE INVENTION

A first aspect of the invention is directed to an inspection system comprising a a first and second computer controlled robotic arm that each have five degrees of freedom (x, y, z, α, β) and respectively control position, tilt and yaw of the first and second probes for inspection of a workpiece, wherein the computer control ensures that the two robotic arms simultaneously scan the probes over the workpiece, without interfering with each other.

Typically, the inspection system further comprises a computer control system, wherein the workpiece is mounted in chucks on a turntable, and signals from the probes, the turntable and the first and second robotic arms are controlled by the computer control system.

Typically, the inspection system is for ultrasonic inspection of a workpiece, and further comprises an ultrasonic inspection tank filled with a liquid, the first and second probe comprise ultrasonic probes and the workpiece and first and second ultrasonic probes are submerged within the liquid.

Optionally, the first probe is a conventional ultrasonic probe and the second probe is a phased array probe, and the computer control system ensures that the first and second robotic arms scan the first and second probes over the workpiece whilst keeping each probe positioned in a proper orientation to and appropriate distance from the surfaces of the workpiece being scanned.

Optionally the system comprises an overhead crane for introducing and removing the workpiece from the inspection tank.

Optionally, workpiece has rotational symmetry.

Optionally the workpiece is a bladed disk.

A second aspect is directed to a method of simultaneously scanning a workpiece with two probes comprising the steps of:

providing an ultrasonic inspection system comprising a computer controlling a first and second computer controlled robotic arm that each have five degrees of freedom (x, y, z, α, β) and respectively control position and tilt and yaw of first and second probes for inspection of the workpiece, wherein the computer ensures that the two robotic arms simultaneously scan the probes over the workpiece, without interfering with each other.

Typically the workpiece has rotational symmetry.

Optionally the workpiece is a bladed disk.

Typically the system comprises a turntable for rotating the workpiece whose rotation is computer controlled by the computer controller.

In some embodiments, the first probe comprises a conventional UT probe and the second probe comprises a phased array probe.

Typically, each probe arm is controlled using a protocol that depends on an equation defining a to-be-scanned surface of the workpiece, wherein the protocol enables the two sensors to scan the work piece simultaneously while preventing the sensors and their robotic arms from colliding thereby improving examination speed and inspection rate.

### DESCRIPTION OF THE FIGURES

For a better understanding of the invention and to show how it may be carried into effect, reference will now be made, purely by way of example, to the accompanying Figures, wherewith it is stressed that the particulars shown are by way of example and for purposes of illustrative discussion of the preferred embodiments of the present invention only, and are presented in the cause of providing what is believed to be the most useful and readily understood description of the principles and conceptual aspects of the invention.

In the drawings, like components are generally designated by like reference numerals, wherein:

FIG. 1 is a schematic representation of a prior art ultrasonic inspection system for inspecting bladed disks and the like, which is available from Scanmaster;

FIG. 2 is a schematic representation of an improved ultrasonic inspection system for inspecting bladed disks and the like, that is disclosed herein.

### DESCRIPTION OF EMBODIMENTS

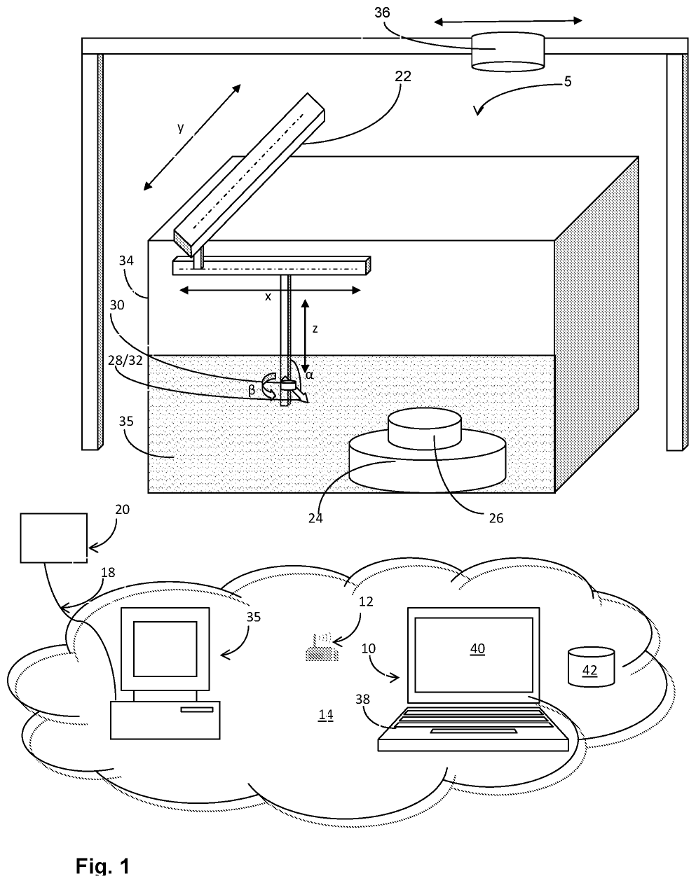

With reference to FIG. 1, a prior art inspection system 5 is schematically shown. Prior art inspection system comprises a dedicated system computer 10 in data communication via a hub 12 and an Ethernet 14, possibly with an additional control computer 16 that is coupled by a USB cable 18 to a control box 20 that controls a robotic arm 22 having five degrees of freedom (x, y, z, α, β), a turntable 24 supporting a chuck for holding a workpiece 26 to the inspected, and also sends and receives ultrasonic sensor data to and from a conventional ultrasonic probe 28, or a phased array probe 30 held in a probe holder 32 that is a specially designed to enable rapid removal of the UT probe and its replacement with a phased array probe.

The turntable 24, workpiece 26 and probe end of the robotic arm 22 are situated within a coupling liquid 35 such as water in inspection tank 34.

An overhead crane 36 may be provided for introducing and removing disks and other workpieces 26 to be inspected.

The workpiece 26 reference code is entered into the dedicated system computer 10 via an input peripheral such as a keyboard 38 or by selection from a list displayed on the GUI 40 of the dedicated system computer 10 which can access a full description from a database 42 of data provided by the manufacturer which may be loaded into the dedicated systems computer or stored elsewhere on the Internet, such as in the cloud, for example. The control computer 16 operating under the dedicated system computer 10 sends instructions to the robot arm 22 and turntable 24 for the controlled scanning of the probe over the entire surface of the disk and collects data that is then sent to the dedicated system computer 10 where it is analyzed and displayed on the GUI 40 and reports are generated.

Other computer control systems may be used, such as a single computer for control, data entry and analysis, or a distributed computer involving the cloud, for example.

A conventional ultrasonic probe 28 may be used to scan the near zone of the inspected part. Then, after switching to a phased array probe 30 and by using Formatted: Not Highlight dynamic depth focusing, it is possible to cover far and medium inspection zones, at depths that are tunable in accordance with the focal law. Using dynamic time dependent reception delay algorithms the probe may be focused on the depths where echoes originate and the positioning can then be improved further by applying time-gain-correction algorithms. This enables several zones to be scanned at once, with high resolution.

Despite the relative efficiency of the system of FIG. 1, the two probes have to be used sequentially with an intermediate downtime while the probe is switched from one system to another.

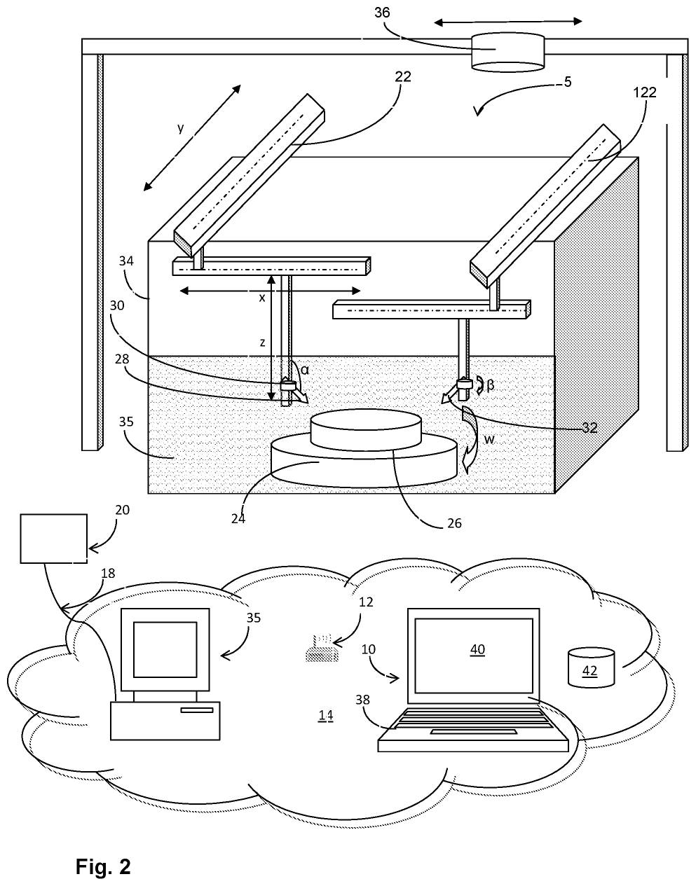

With reference to FIG. 2, an improved system 105 is shown, that comprises the various components of the prior art system of FIG. 1, mutatis mutandis, however, instead of one robotic arm 22 having five degrees of freedom (x, y, z, α, β) provided with a probe holder 32 that can accept either a conventional ultrasonic probe 28, or a phased array probe 30, two robotic arms 22, 122 are provided, each having five degrees of freedom (x, y, z, α, β), the first robotic arm 22, being provided with a conventional ultrasonic probe 28, and the second robotic arm 122 being provided with a phased array probe 30 directly connected to a standard gimbal-gimbal probe manipulator.

The first and second robotic arms 22, 122 are both controlled by the control computer 16 which ensures that they do not interfere with each other. In one embodiment, the x, y and z movements are provided by chains similar to those used for bicycles, where the x movement is by moving the y and z system along a fixed beam in the x axis. The y beam 22 of the first robotic arm 22 and the y beam 122 of the second robotic arm 122 may be mounted on different sides of the turntable 24 and at different elevations over the inspection tank 34. In this manner, the y beams which are fixed and which move the probes back and forth in the y direction are in no danger of collision, and the x beams that move the probes in the orthogonal direction from left to right operate at different heights and come from different sides of the turntable 26.

The scanning protocol used to control each probe arm 22, 122 depends on the equation of the surface of the workpiece 26. This scanning protocol is modified to enable the two sensors to scan the work piece simultaneously while preventing the sensors 28, 32 and robotic arms 22, 122 from ever colliding. For example, it may designate one sensor 28 as the primary sensor and the second probe arm 122 and sensor 32 as inferior to the primary sensor 28 and stop the secondary arm 122 from moving if doing so will cause a collision, reversing the scanning of the secondary probe 32 if necessary. The scanning protocol is stored in the memory of the control computer 35 which uses the equation of the surface being scanned provided by the manufacturer of the workpiece 26 in order to be able to determine the set of coordinates at which to position each scanner probe 28, 32 in order to scan a given point on the surface of the workpiece 26.

By way of implementation only, Scanmaster™'s existing immersion system with a first robotic arm 22 may be modified by providing a second robotic arm 122 controlling Scanmaster™'s commercially available 128 channel phased array system LS-200 PA provided with linear, annular and matrix transducers mounted on the second arm 122. Both probes 28, 32 may be manipulated with gimbal-gimbal probe manipulators.

Scanmaster™'s CSI (C-scan Imaging Software) that supports both conventional and plased array UT, was used to superimpose and analyze the data from the two probes 28, 32.

It has been estimated that this typically reduces the overall test cycle including introducing and removing the workpiece 26 by 30%, with corresponding increases in throughput.

Persons skilled in the art will appreciate that the present invention is not limited to what has been particularly shown and described hereinabove. Rather the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. An inspection system comprising a computer controlled a first and second computer controlled robotic arm that each have five degrees of freedom (x, y, z, α, β) and respectively control position and tilt of first and second probes for inspection of a workpiece, wherein the computer control ensures that the two robotic arms simultaneously scan the probes over the workpiece, without interfering with each other.

2. The inspection system of claim 1, further comprising a computer control system, wherein the workpiece is mounted in a chuck that is mounted on a turntable, and signals from the probes, the turntable and the first and second robotic arms are controlled by the computer control system.

3. The inspection system of claim 1 for ultrasonic inspection of a workpiece, and further comprises an ultrasonic inspection tank filled with a liquid, and wherein during inspection the first and second probe comprise ultrasonic probes and the workpiece and first and second ultrasonic probes are submerged within the liquid.

4. The inspection system of claim 2 wherein the first prove is a conventional ultrasonic probe and the second probe is a phased array probe, and the computer control system ensures that the first and second robotic arms scan the first and second probes over the workpiece whilst keeping each probe positioned in a normal direction and appropriate distance from the surfaces of the workpiece being scanned.

5. The system of claim 3, further comprising an overhead crane 36 for introducing and removing the workpiece from the inspection tank.

6. The system of claim 1 wherein the workpiece has rotational symmetry.

7. The system of claim 1 wherein the workpiece is a bladed disk.

8. A method of simultaneously scanning a workpiece with two probes comprising the steps of:
providing an ultrasonic inspection system comprising a computer controlling a first and second computer controlled robotic arm that each have five degrees of freedom (x, y, z, α, β) and respectively control position and tilt of first and second probes for inspection of the workpiece, wherein the computer ensures that the two robotic arms simultaneously scan the probes over the workpiece, without interfering with each other.

9. The method of claim 8 wherein the workpiece has rotational symmetry.

10. The method of claim 8 wherein the workpiece is a bladed disk.

11. The method of claim 8 further comprising a turntable for rotating the workpiece whose rotation is computer controlled by the computer controller.

12. The method of claim 8 wherein the first probe is a conventional UT probe and the second probe is a phased array probe.

13. The method of claim 8 each probe arm is controlled using a protocol that depends on an equation defining a to-be-scanned surface of the workpiece, wherein the protocol enables the two sensors to scan the work piece simultaneously while preventing the sensors and their robotic arms from colliding.
